(19) United States
(12) Patent Application Publication
(10) Pub. No.: US 2010/0213334 A1
(43) Pub. Date: Aug. 26, 2010

(54) SHELF MOUNTING SYSTEM

(76) Inventor: John Davenport, Clarendon Hills, IL (US)

Correspondence Address: MICHAEL P. MAZZA, LLC, 686 CRESCENT BLVD., GLEN ELYN, IL, 60137, US

(21) Appl. No.: 12/774,858

(22) Filed: May 6, 2010

Related U.S. Application Data
(63) Continuation-in-part of application No. 11/744,423, filed on May 4, 2007.

(51) Int. Cl. F16M 13/02; B23P 11/00

(52) U.S. Cl. 248/220.21; 29/428

(57) ABSTRACT

A shelf mounting system with a rigid shelf track having a face substantially free of apertures other than those used to mount the track to a wall, two sides having slots, and a bracket to engage and support the shelf track. In the preferred embodiment, the bracket includes a pair of opposed side flanges joined at a proximal end, and having two free distal ends terminating in engaging portions attachable to the track slots, using a V-lock. A method for constructing a shelf mounting system according to the present invention is also provided.

As to common subject matter, this application claims priority from U.S. Ser. No. 11/744,423 filed May 4, 2007, titled: “Shelf Mounting System”.

### BACKGROUND OF THE INVENTION

The present invention relates to a shelf and/or accessory mounting system. Current shelf mounting products and systems are constructed from vertical shelf tracks that contain front slots, and brackets that fit into these front slots for shelving and other hanging accessories. These tracks are typically constructed from steel vertical uprights, which are fastened to a wall by fasteners, such as anchors, screws, bolts, hooks and so forth.

Current shelf mounting products and systems have not gained wide acceptance into the home market even though they were designed for home use. One of the problems with the current products and systems is that the color of the track and the bracket do not blend easily with the typical household shelving or wall color schemes. Another problem is that the current shelf mounting products and systems are not aesthetically pleasing because of the position of the slots on the front face of the shelf tracks. A still further problem is that loose-fitting brackets that are not securely locked into the shelf tracks allow a back-and-forth sway of the bracket and the shelving and, if bumped from underneath, could disengage the bracket allowing the shelving to fall. Current designs simply attach a free-hanging bracket, that does not have adequate support on the shelf track.

Accordingly, it would be advantageous to provide a shelf mounting system that includes shelf tracks that have side slots and have a front face that is substantially free from slots in order to blend with the color schemes of the typical household and to be aesthetically pleasing.

Definition of Claim Terms

The following terms are used in the claims of the patent as filed and are intended to have their broadest meaning consistent with the requirements of law. Where alternative meanings are possible, the broadest meaning is intended. All words used in the claims are intended to be used in the normal, customary usage of grammar and the English language.

“Shelf track” means an elongated member mountable on a wall and having slots for receiving brackets therein.

“Bracket” means a support member.

“Arcuate” means curvilinear.

### SUMMARY OF THE INVENTION

The objects mentioned above, as well as other objects, are solved by the present invention, which overcomes disadvantages of prior shelf mounting systems, while providing new advantages not believed associated with such systems.

In a preferred embodiment, a shelf mounting system is provided which includes a shelf track adapted to be mounted on a wall. The shelf track has a face and two sides having slots. One or more shelving brackets are also provided, and adapted to securely engage the side slots of the shelf track to support shelving. Preferably, the one or more brackets each have an opposing side flange for supporting a shelf, a pair of inwardly-facing and downwardly-directed tabs for engaging the slots on the sides of the shelf track, and at least one distal end including a planar or arcuate surface adapted to abut the face of the shelf track and aid in supporting the one or more brackets on the shelf track. This aids in receiving and distributing weight when a load is placed on the one or more brackets. Preferably, the tabs extend in a direction substantially perpendicular to a longitudinal axis of the side flanges, and the tabs form a locking angle of between about 1-5 degrees, to ensure that the shelving brackets are securely engaged to the shelving track. Most preferably, the locking angle is about 3 degrees.

In one preferred embodiment, the shelf track is a vertically extending, rigid member, and the face of the shelf track is substantially free of apertures other than those used to mount the track to the wall. The opposed side flanges may but need not be joined at a proximal end, and they may each have a free distal end laterally moveable between an open position in which the free distal ends are separated by a distance greater than a width of the track, and a closed position in which the distal ends each securely engage the side slots.

In an alternative embodiment, the brackets may include one or more fins mounted on at least one of the opposed side flanges. The one or more fins may have an aperture for receiving: (a) a fastener which may be attached to shelving; or (b) a cushioning pad.

Each of the free distal ends may terminate in an arcuate surface adapted to abut the face of the track when the track is engaged with the bracket, to thereby aid in load distribution of the shelving weight onto the track. Each of the tabs may be affixed to or integral with the arcuate surface.

In yet another alternative embodiment, a shelf mounting system includes a vertical, rigid shelf track adapted to be mounted on a wall. The track preferably has a face and two sides having a plurality of vertically-spaced slots, and the track is preferably substantially free of apertures other than those used to mount the track to the wall. One or more brackets are provided, and adapted to securely engage the side slots and thereby support shelving. The brackets may each have at least one distal end including a planar or arcuate surface adapted to abut the face of the shelf track, and tabs to engage the slots on the track, to thereby aid in supporting the one or more brackets on the shelf track when a load is placed on the one or more brackets. The tabs preferably extend in a direction substantially perpendicular to a longitudinal axis of the side flanges, and the tabs form a locking angle of between about 1-5 degrees. In an alternative preferred embodiment, each of the one or more brackets includes a pair of opposed side flanges joined at a proximal end, and the side flanges have two free distal ends laterally moveable between an open position in which the free distal ends are separated by a distance greater than a width of the track, and a closed position in which the distal ends each securely engage the side slots.

In still another embodiment of the invention, a method is provided for creating a shelf mounting system, and includes the step of providing a shelf track adapted to be mounted on a wall, the shelf track having a face free of apertures other than those used to mount the track to the wall, and the track having a plurality of side slots. A bracket is also provided, and adapted to engage the side slots. The bracket preferably has two distal ends including opposing planar or arcuate surfaces adapted to abut the face of the shelf track and thereby aid in supporting the bracket on the shelf track when a load is placed on the bracket. The bracket preferably has opposing side flanges for supporting a shelf. An end of each side flange has a pair of tabs for engaging the slots on the sides of the shelf track. The tabs preferably extend in a direction substantially perpendicular to a longitudinal axis of the side flanges. The bracket is securely engaged within the side slots, and the tabs extend in a direction substantially perpendicular to a longitudinal axis of the side flanges. The tabs form a locking angle of between about 1-5 degrees and, most preferably, about 3 degrees. The bracket may include a pair of opposed side flanges joined at a proximal end and having two free distal ends. The free distal ends may be laterally moveable between an open position in which the free distal ends are separated by a distance greater than a width of the track, and a closed position in which the distal ends are engaged to the track. Each of the free distal ends may terminate in an engaging portion attached to or integral with an arcuate surface of the side flange; the arcuate surface may be adapted to abut the face of the track when the track is engaged with the bracket.

### BRIEF DESCRIPTION OF THE DRAWINGS

The novel features which are characteristic of the invention are set forth in the appended claims. The invention itself, however, together with further objects and attendant advantages thereof, will be best understood by reference to the following description taken in connection with the accompanying drawings. The drawings illustrate currently preferred embodiments of the present invention. As further explained below, it will be understood that other embodiments, not shown in the drawings, also fall within the spirit and scope of the invention.

FIG. 1 is an isometric view showing the shelf track and the bracket;

FIG. 2 is a view of a section of the pair of the opposed side flanges;

FIG. 3A is a top view showing an open position of the free distal ends of the bracket and a free shelf track;

FIG. 3B is a top view showing a closed position of the free distal ends of the bracket engaging the shelf track;

FIG. 4 is a rear view showing the bracket before and after engaging the shelf track;

FIG. 5 is an isometric view showing the shelf track/wall riser and shelf-supporting bracket of an alternative preferred embodiment;

FIG. 6 is a side view of FIG. 5;

FIG. 7A is a top view of FIG. 5 showing an open position of the free distal ends of the bracket engaging the track/will riser;

FIG. 8 is a rear view showing the bracket before and after engaging the shelf/track wall riser; and

FIG. 8A is an enlarged view of the encircled portion of FIG. 8.

The components in the drawings are not necessarily to scale, emphasis instead being placed upon clearly illustrating the principles of the present invention. In the drawings, like reference numerals designate corresponding parts throughout the several views.

### DETAILED DESCRIPTION OF THE PREFERRED EMBODIMENTS

Set forth below is a description of what are currently believed to be the preferred embodiments and/or best examples of the invention claimed. Future and present alternatives and modifications to these preferred embodiments are contemplated. Any alternatives or modifications which make insubstantial changes in function, in purpose, in structure or in result are intended to be covered by the claims of this patent.

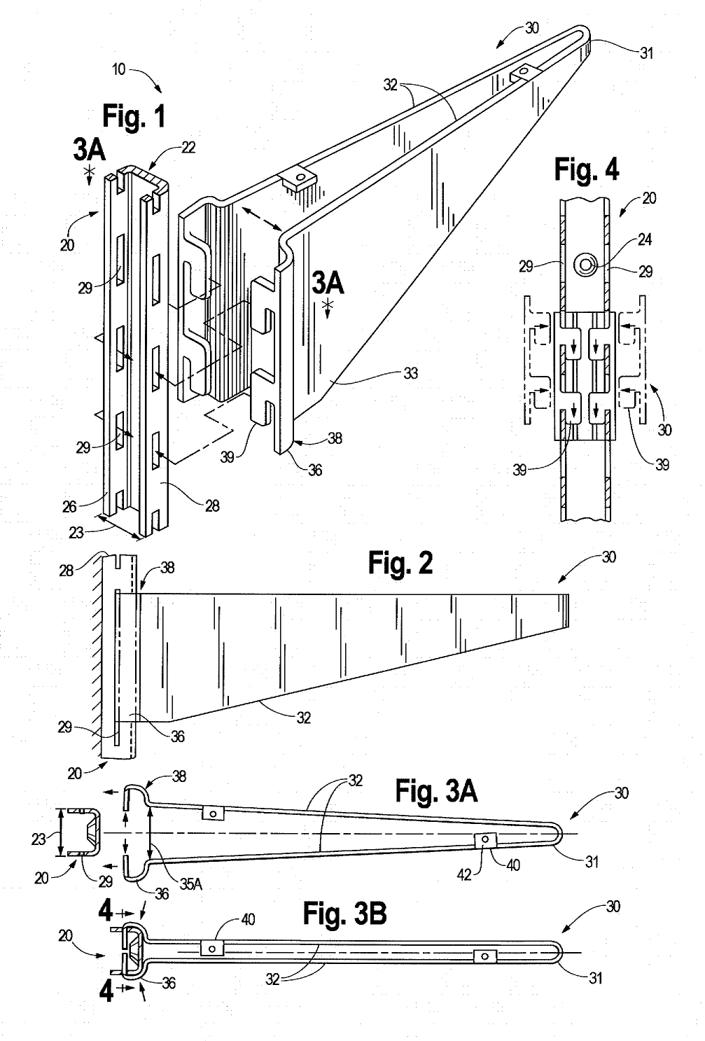

Referring first to FIG. 1, a preferred embodiment of the invention is shown, in which shelf mounting system 10 includes at least one shelf track 20 and at least one bracket 30 for supporting and engaging the shelf track 20. Shelf track 20 includes a face 22, a wall mounting aperture 24, a first side 26, a second side 28 and a width 23. Both first side 26 and second side 28 have side slots 29. Shelf track 20 is preferably a rigid member, which is free from apertures on face 22 other than wall mounting aperture 24. Bracket 30 includes a pair of opposing side flanges 32 joined at a proximal end 31 and has two free distal ends. Proximal end 31 may be curved, squared-off, cramped or otherwise bent, for example.

Referring to FIG. 2, a side view showing a through section of the pair of opposing side flanges 32 of bracket 30 is provided. Flanges 32 are preferably rigid members in order to withstand the weight of the shelf and the other hanging accessories mountable on top of bracket 30.

Referring to FIGS. 3A and 3B, FIG. 3A shows free distal ends 33 of flanges 32 in an open position separated by a distance, width 35A, which is greater than width 23 of adjacent free shelf track 20. Free distal ends 33 are flexibly laterally moveable between the open position and a closed position when free distal ends 32 are separated by a distance 35B, which is less than the width 23 of shelf track 20, as shown in FIG. 3B. Free distal ends 32 of bracket 30 preferably terminate in an engaging portion 38 attached to or made from an arcuate surface 36. Surface 36 could be of any shape and geometry, preferably matching the shape of face 22 of shelf track 20.

In a further embodiment, bracket 30 may include at least one fm 40 with an aperture 42 for receiving a fastener such as nails, screws and so forth, in order to fasten a shelf (not shown) mountable on top of bracket 30. Fin 40 provides additional stability for bracket 30 and the mountable shelf (not shown).

Referring now to FIG. 4, a rear view of shelf track 20 and bracket 30 is provided. Securing tab 39 of engaging portions 38 of bracket 30 is shown before (in dotted lines) and after (in solid lines) slideably engaging into side slots 29 of shelf track 20. One or more of securing tabs 39 may be permanently attached to side slots 29 of track 20. However, this is not a preferred embodiment because it makes it difficult to transport shelf track 20 and bracket 30 is no longer adjustable to track 20.

FIG. 4 shows the steps of creating a shelf mounting system, which includes providing shelf track 20 with side slots 29, which is free of apertures on its front face 22 other than those used to mount track 20 to the wall, such as aperture 24, providing a bracket 30 with at least one securing element, such as securing tab 39, which engages side slots 29.

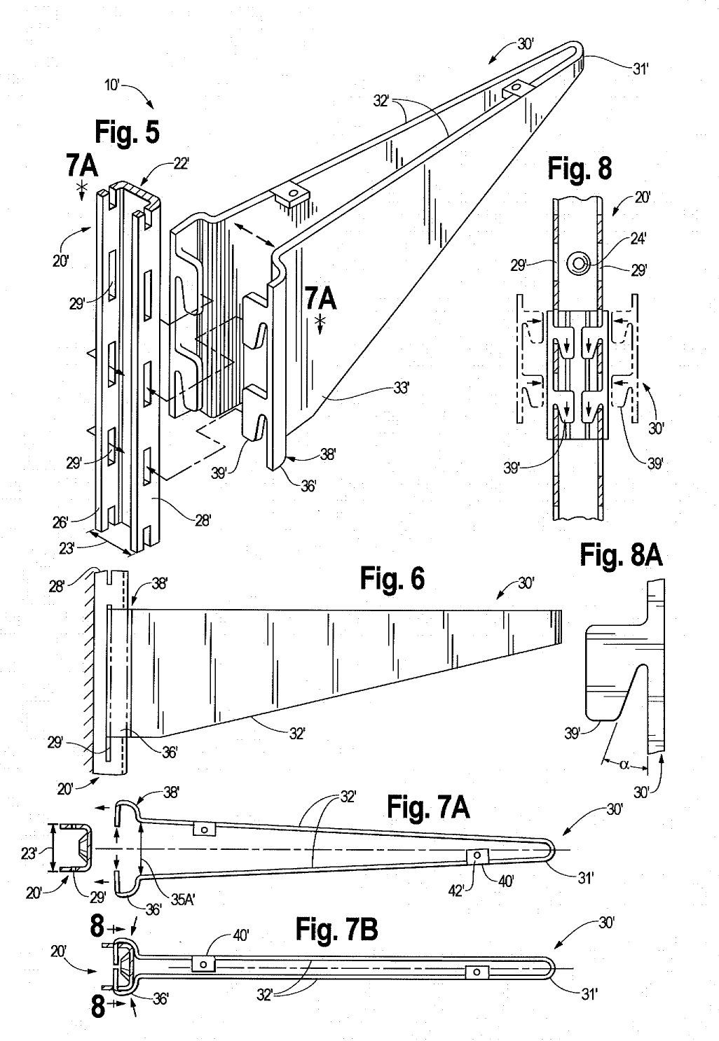

Referring now to FIGS. 5-8A, an alternative embodiment of the invention is shown, in which the inner surface of the bracket tabs 39 forms a predetermined angle with an inner edge of engaging portion 38, as shown. Referring to FIG. 8A, angle α or “alpha” (the “locking angle”) is preferably between about 1°-5°, and most preferably about 3°. It has been found that this “V-lock” design enhances locking frictional engagement of tabs 39 within side slots 29 of track 20: the more weight that is placed on shelf bracket 30, the stronger the engagement of tab 39 to wall riser 20 via its slot 29.

Persons of ordinary skill in the art will recognize that the inventions disclosed here provide shelving brackets that are securely locked into the shelf track. Even if bumped from underneath, the shelf track will not disengage from the shelving bracket. Given the locking angle, locking tabs 39 insure that the bracket engages the shelf track for secure attachment.

It will be understood that various modifications to the preferred embodiment disclosed above may be made. The above description is not intended to limit the meaning of the words used in the following claims that define the invention. Rather, it is contemplated that future modifications in structure, function or result will exist that are not substantial changes and that all such insubstantial changes are intended to be covered by the following claims.

I claim:

1. A shelf mounting system, comprising:
a shelf track adapted to be mounted on a wall, the track having a face and two sides having slots;
one or more brackets adapted to securely engage the side slots and to support shelving, the one or more brackets each having an opposing side flange for supporting a shelf and a pair of inwardly-facing and downwardly-directed tabs for engaging the slots on the sides of the shelf track, and at least one distal end including a planar or arcuate surface adapted to abut the face of the shelf track and aid in supporting the one or more brackets on the shelf track, to thereby aid in receiving and distributing weight when a load is placed on the one or more brackets;
wherein the tabs extend in a direction substantially perpendicular to a longitudinal axis of the side flanges, and the tabs form a locking angle of between about 1-5 degrees.

2. The shelf mounting system of claim 1, wherein the locking angle is about 3 degrees.

3. The shelf mounting system of claim 1, wherein the shelf track is a vertically extending, rigid member, and the face of the shelf track is substantially free of apertures other than those used to mount the track to the wall.

4. The shelf mounting system of claim 1, wherein the opposed side flanges are joined at a proximal end, and the side flanges each have a free distal end laterally moveable between an open position in which the free distal ends may be separated by a distance greater than a width of the track, and a closed position in which the distal ends each securely engage the side slots.

5. The shelf mounting system of claim 4, wherein the brackets include one or more fins mounted on at least one of the opposed side flanges, the one or more fins having an aperture for receiving: (a) a fastener which may be attached to shelving; or (b) a cushioning pad.

6. The shelf mounting system of claim 4, wherein each of the free distal ends terminates in an arcuate surface adapted to abut the face of the track when the track is engaged with the bracket, to thereby aid in load distribution of the shelving weight onto the track.

7. The shelf mounting system of claim 6, wherein each of the tabs are affixed to or integral with the arcuate surface.

8. A shelf mounting system, comprising:
a vertical, rigid shelf track adapted to be mounted on a wall, the track having a face and two sides having a plurality of vertically-spaced slots, and the track being substantially free of apertures other than those used to mount the track to the wall; and
one or more brackets adapted to securely engage the side slots and thereby support shelving, the one or more brackets each having at least one distal end including a planar or arcuate surface adapted to abut the face of the shelf track and tabs to engage the slots on the shelf track, to thereby aid in supporting the one or more brackets on the shelf track when a load is placed on the one or more brackets;
wherein the tabs extend in a direction substantially perpendicular to a longitudinal axis of the side flanges, and the tabs form a locking angle of between about 1-5 degrees.

9. The shelf mounting system of claim 8, wherein the locking angle is about 3 degrees.

10. The shelf mounting system of claim 7, wherein each of the one or more brackets comprise a pair of opposed side flanges joined at a proximal end, and the side flanges have two free distal ends laterally moveable between an open position in which the free distal ends are separated by a distance greater than a width of the track, and a closed position in which the distal ends each securely engage the side slots.

11. A method for creating a shelf mounting system, comprising the steps of:
providing a shelf track adapted to be mounted on a wall, the shelf track having a face free of apertures other than those used to mount the track to the wall, and the track having a plurality of side slots;
providing a bracket adapted to engage the side slots, the bracket having two distal ends including opposing planar or arcuate surfaces adapted to abut the face of the shelf track and thereby aid in supporting the bracket on the shelf track when a load is placed on the bracket, the bracket having opposing side flanges for supporting a shelf, and an end of each side flange having a pair of tabs for engaging the slots on the sides of the shelf track, wherein the tabs extend in a direction substantially perpendicular to a longitudinal axis of the side flanges; and
securely engaging the bracket within the side slots;
wherein the tabs extend in a direction substantially perpendicular to a longitudinal axis of the side flanges, and the tabs form a locking angle of between about 1-5 degrees.

12. The method of claim 11, wherein the locking angle is about 3 degrees.

13. The method of claim 11, wherein the bracket includes a pair of opposed side flanges joined at a proximal end and having two free distal ends.

14. The method of claim 11, wherein the free distal ends are laterally moveable between an open position in which the free distal ends are separated by a distance greater than a width of the track, and a closed position in which the distal ends are engaged to the track.

15. The method of claim 14, wherein each of the free distal ends terminates in an engaging portion attached to or integral with an arcuate surface of the side flange, the arcuate surface being adapted to abut the face of the track when the track is engaged with the bracket.
